(19) United States
(12) Patent Application Publication
(10) Pub. No.: US 2023/0027581 A1
(43) Pub. Date: Jan. 26, 2023

(54) SYSTEM AND METHOD FOR SELECTING A TAX RETURN FROM MULTIPLE TAX RETURN PROCESSORS

(71) Applicant: Halcyon Still Water, LLC, Red Bank, NJ (US)

(72) Inventors: CONWAY K. DONALDSON, Fair Haven, NJ (US); James W. McGowan, Flemington, NJ (US); Elizabeth A. Boonin, East Setauket, NY (US)

(21) Appl. No.: 17/874,058

(22) Filed: Jul. 26, 2022

Related U.S. Application Data
(60) Provisional application No. 63/225,796, filed on Jul. 26, 2021.

(51) Int. Cl. G06Q 40/00

(52) U.S. Cl. CPC G06Q 40/123

(57) ABSTRACT

The system automatically selects an output data structure from among more than one output data structure generated by separate processors. For instance, the output data structures may have different performance scores, and the system and method may compute difference scores to compare the independently determined performance scores of the output data structures. Depending on the magnitude of the difference score, the output data structures can be determined to be valid or to be invalid so that further processing is performed to generate a valid output data structure. In some instances, the data structures are tax returns, and the system automatically computes a tax return, and the comparing process advantageously yields a tax return that optimizes a tax filing strategy.

### CROSS-REFERENCE TO RELATED APPLICATIONS

This disclosure claims priority to, and the benefits of, U.S. Ser. No. 63/225,796 filed on Jul. 26, 2021, and entitled “SYSTEM AND METHOD FOR SELECTING A TAX RETURN FROM MULTIPLE TAX RETURN COMPUTERS,” which is hereby incorporated by reference in its entirety for all purposes.

### TECHNICAL FIELD

This disclosure generally relates to automatically selecting an output data structure, and more particularly, to a system and method for automatically selecting an output data structure from among more than one output data structure generated by separate processors.

### BACKGROUND

Tax returns are often prepared by automated or semi-automated systems. However, due to the significantly unstructured nature of input data assembled for generating tax returns, as well as different algorithmic assumptions, rules, and processes possible under different and complex tax regulations, the different systems may generate different tax returns showing different amounts of tax owed for a same collection of input data. Correspondingly, traditional machine methods often do not adequately perform, causing automated methods to return undesirable results. Thus, there remains a need for an automated system and method for selecting a tax return from among more than one tax return generated by separate processors, wherein each tax return may include a different amount owed. More generally, there is a need for automatically selecting an output data structure from among more than one output data structure generated by separate processors, wherein each output data structure includes a performance score. More particularly, the output data structure may be a tax return, and the performance score may be an amount of tax owed.

### SUMMARY

In various embodiments, the system may automatically select an output data structure from among more than one output data structure generated by separate processors, each output data structure having a performance score. The method may include sending, by a requesting processor and to a first processor, a request for a first output data structure to be generated by the first processor; sending, by the requesting processor and to a second processor, a request for a second output data structure to be generated by the second processor, wherein the first processor and the second processor generate independently and simultaneously the first output data structure having a first performance score and the second output data structure having a second performance score, the first output data structure and the second output data structure forming an output data structure group; computing, by the requesting processor, a difference score of the output data structure group, the difference score being a difference between the first performance score and the second performance score; comparing, by the requesting processor, the difference score to a discrepancy threshold to determine whether the first output data structure and the second output data structure of the data structure group are valid data structures; and selecting, using the requesting processor, an approved data structure based on a first selection criteria from among the first output data structure and the second output data structure of the data structure group in response to at least one of the first output data structure or the second output data structure being a valid data structure.

In various embodiments, the first output data structure may be a first tax return. The second output data structure may be a second tax return. The request for an output data structure to be generated may be a request for a tax return to be completed. The first performance score may be a greater amount of taxes owed as indicated by the first tax return. The second performance score may be a lesser amount of taxes owed as indicated by the second tax return. In various embodiments, the approved data structure is a tax return to electronically file with a government computer system.

The first processor may forward the request for the output data structure to be generated to the second processor after the receiving the request at the first processor. The first processor and the second processor may both receive the request for the output data structure to be generated from the requesting processor. The discrepancy threshold may be a percentage of difference amongst the tax returns. The discrepancy threshold may be a magnitude of difference amongst the tax returns. In various instances, the first selection criteria is selected from a group including a lowest tax owed, a fewest deductions, a most deductions, a highest tax owed, a lowest risk score, a highest risk score, and a weighted combination of criteria.

The method may include applying a mediation procedure by the third processor in response to the difference score being greater than or equal to the discrepancy threshold. The mediation procedure may include at least one of (1) generating by a further processor, a further output data structure having a further performance score for inclusion in the output data structure group and (2) removing one or more output data structure from the output data structure group.

### BRIEF DESCRIPTION OF THE DRAWINGS

The accompanying drawings, wherein like numerals depict like elements, illustrate exemplary embodiments of the present disclosure, and together with the description, serve to explain the principles of the disclosure. In the drawings:

FIG. 1 shows a system for automatically selecting an output data structure from among more than one output data structure generated by separate processors, in accordance with various embodiments; and

FIG. 2 illustrates a flowchart of an exemplary method for automatically selecting an output data structure from among more than one output data structure generated by separate processors, in accordance with various embodiments.

### DETAILED DESCRIPTION

The system may include selecting an output data structure from among multiple data structures generated by separate processors. For instance, in various embodiments, multiple processors may perform complex decision and calculation tasks and may arrive at different results due to variations in processing assumptions, applied criteria, automatic decisions, artificial intelligence, and machine learning technologies among the different processors. Thus, there remains a need for a system and method to automatically compare multiple outcomes and select a result most closely aligned with potentially contradictory inputted user preferences (that may have been input about the same time), a result most closely aligned with accurate results, and/or a result most closely aligned with precise results. Accurate results may include results that are closer to a “true” or theoretically correct result. A “true” result may be, for example, determined by comparison to a result computed by a governing authority, wherein such authority's result is defined to be the “true” result, or a “true” result may be one in which a judicial body has adjudicated that such a result is correct. Precision may include results that are similar to one another. Accuracy and precision are independent. Results can be accurate in that the results center around the “true” value, but vary from one another. Results can be precise in that the results agree with each other, but are in no way accurate.

Moreover, while various systems and methods will be detailed in the following paragraphs, one instructive scenario involving tax preparation may be useful to consider before more detailed reference to the figures. The system and method which will be discussed further herein may be used for selecting a tax return from multiple tax return processors.

The system may be useful for selecting a tax return from more than one tax return computer or entity, where the tax return computer or entity may include one or more algorithm for automatically computing a tax return, and/or any other method of preparing a tax return. Employing or utilizing more than one tax return computer or entity advantageously yields a tax return that optimizes a tax filing strategy such as, for example, maximizing a monetary return, minimizing the chances of an audit, or other types of inputted preferences as will be described herein.

For instance, a tax return completion request may be submitted. The tax return completion request may be a request from a tax client to have a tax return completed. The system (or a second computer) can receive tax return completion request from a first computer. Two or more tax computers may be selected to process the tax return completion request. Each tax computer can prepare or return a completed tax return. All or a subset of the tax computers that return the completed tax return may form a tax return group. Each computer completes a return based on the same information. For example, three of the tax computers may each complete a federal 1040 form for the same client. Collectively, the 3 proposed returns form a group. In practice, there can be tremendous variation among the three proposed returns. A “difference score” is computed across the tax return group. This can vary with different technical implementations. For example, the difference score for the tax group may be defined as a difference between maximum tax owed (from the return with the maximum tax owed) minus the minimum tax owed (from the return with the minimum tax owed). In further instances, various machine learning and/or artificial intelligence calculations may be implemented.

The “difference score” is compared against a threshold t. The threshold determines that difference defined above is trivial, for example, less than 3% of the maximum value, or a fixed value such as $1,000. If three different tax returns only differ in tax owed in an amount of $300, the returns are considered “valid,” and any one can be selected as the return sent for filing. The exact selection depends on the disposition of the filer. Knowing all returns are valid, an aggressive filer may select the return with the lowest tax owed. Alternatively, a filer may select the return with the fewest deductions, in the hopes of minimizing the chance of an audit.

If the “difference score” is less than t, in various embodiments, an algorithm assigns a set of scores for each return in the tax return group. For instance, the algorithm may assign a score of 1 to the return claiming the lowest taxes owed, a 2 to the return claiming the second lowest taxes owed, and so on. The group is a name for the set of returns computed, in which only 1 return will be submitted.

If the difference score is above or equal to t, in various embodiments, a mediation procedure may be applied. The mediation procedure may involve, for example, having a more sophisticated return computer prepare a return; adding more tax computers; removing some tax computers; any combination of the above; or any other means of mediating the selection or providing a more accurate result.

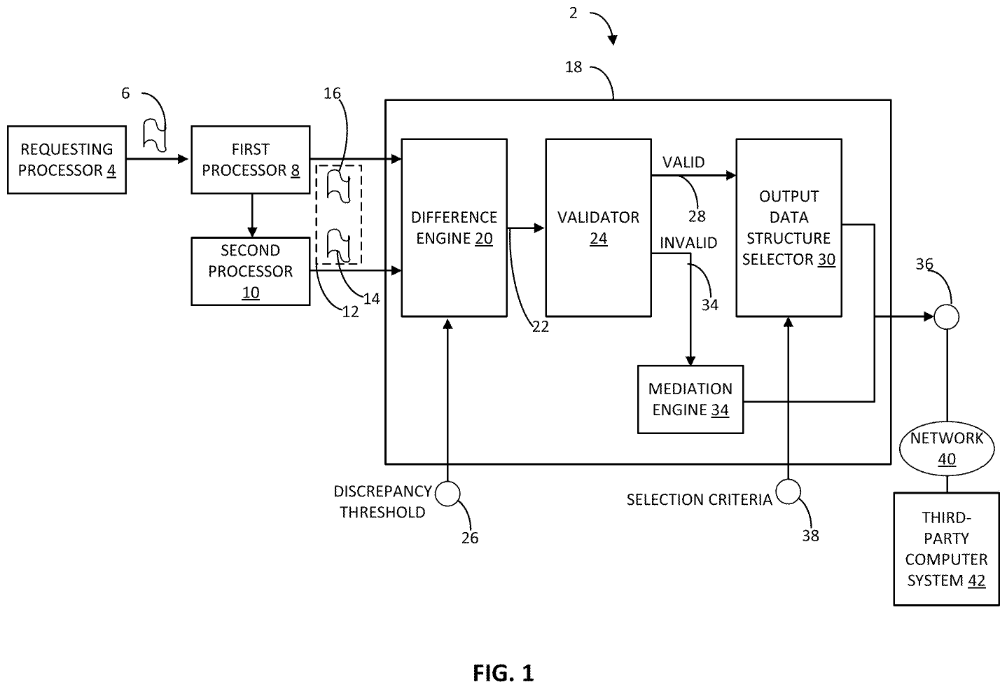

With reference to FIG. 1, system 2 automatically selects an output data structure from among more than one output data structure generated by separate processors. Reference to “processor[s]” will be made throughout this document. A processor may include, for example, a computer, or a logical aspect of a computer, or a distributed computing system, memory, distributed memory, and/or a combination thereof. A processor may include one or more distributed or interfacing processors.

The system may include a requesting processor 4. A requesting processor submits a first request data structure 6. For instance, a requesting processor may be a remotely disposed processor that transmits data corresponding to variables associated with a tax return. The first request data structure 6 may also include an electronic request, such as a request for an output data structure to be generated. The output data structure may comprise a tax return. The request data may be in the form of government issued, structured tax forms (e.g., a W-2) or client provided unstructured or semi-structured data (e.g., an expense receipt). Unstructured and semi-structured data may be converted to structured data through automated means, such as machine learning enabled automatic invoice processing. The system may import the forms into the system from electronic records (e.g., the system may obtain a user's W-2 directly from ADP). The system may scan the forms into a system and use Optical Character Recognition (OCR) to convert the forms to digitized text. The system may also receive data that is entered manually. The manual step may be used where the OCR makes a mistake (e.g., $80,000 gets read as 580,000). After the data is extracted, the data may be stored in a few formats, depending on the data source. The system may use JSON for the majority of communication, but the format could be CSV, XML, YAML or various internal formats used by SQL databases (such as MDF).

The first processor 8 may receive the request for the output data structure to be generated from the requesting processor 4. The first processor 8 may forward the request to a second processor 10. Thus, a first processor 8 and a second processor 10 may work in parallel. In other instances, the requesting processor 4 is connected to both the first processor 8 and the second processor 10 and provides the first request data structure 6 to both processors.

The first processor 8 may generate a first output data structure 16 having a first performance score. Similarly, the second processor 10 may generate a second output data structure 14 having a second performance score. While a first and second processor are illustrated, one may appreciate that any number of processors may be implemented to generate any number of output data structures having performance scores. In various embodiments, the output data structures are tax returns, and the performance scores are a number corresponding to a dollar amount of taxes owed. The data structures, such as the first output data structure 16 and the second output data structure 14 may together form an output data structure group 12 comprising a collection of multiple output data structures generated by multiple processors. Each output data structure is associated with a certain tax client and tax form which is tracked by, for instance, a tax client's SSN or EIN. The tax form may be tracked by a form number. A return is any group of forms under a single primary SSN or EIN. A primary SSN is required on all tax forms. A secondary SSN (e.g., a spouse filing jointly or child dependent) may be included with the tax forms, but is superfluous when identifying the tax client. The system may use the tax client's SSN or EIN or form number to track the requests to different processors and to associate the documents into appropriate groups.

Many systems exist for creating completed tax returns such as Quicken, like TurboTax, UltraTax, GoSystem Tax RS, and many others. Each of these systems use some heuristics to guide users through filing, but ultimately the systems are deterministically using a single path. For instance, in New Jersey, the system provides two options for getting property tax relief. For each filer, one is objectively better than the other, and results in a lower tax burden. Quicken may compute both paths and choose the better answer, but that answer may also be part of a New Jersey 1040 filing, wherein the taxpayer fills out the schedules and the schedule provides to the taxpayer which path to take. The current system differs because the current system computes multiple paths that are not provided by the IRS, and that various IRS auditors could agree/disagree with. Is parking at your office tax deductible if you leave your car at the office while taking a business trip? Auditors will disagree and Quicken (and the other tax software) leave that decision to the taxpayer or the CPA. The current system chooses from multiple returns, where the dials for tax burden, risk of audit, and future tax burden all differ. Quicken and the other systems only allow the taxpayer to dial in those different decisions, namely the taxpayer can list the parking as a deduction or not, but it's up to the taxpayer.

The output data structure group 12 may be provided to a third processor 18. The third processor 18 may include various components discussed in greater detail in following paragraphs. As used herein, in various embodiments, third processor 18 may be a separate processor, or third processor 18 may be part of or interface with requesting processor 4. As such, requesting processor 4 may perform any of the third processor 18 functions set forth herein. The combination of components in the third processor 18 may operate to compute a difference score for the output data structures in the output data structure group, the difference score being a difference between the first performance score and the second performance score. For instance, the third processor 18 may include a difference engine 20. The difference engine 20 may receive the first output data structure 16 and the second output data structure 14 of the output data structure group and may subtract the performance scores. The difference of the performance scores may be a difference score 22. The system may determine the performance scores by acquiring data from the “amount owed” or “amount of refund” lines of the completed tax document (output data structure). The data may be summarized (depending on the municipality) as the “overall tax”. Whether an amount is owed or refunded may depend on what was previously paid, which should be a constant.

The third processor 18 may include a validator 24 comprising a logical module to compare the difference score 22 to a discrepancy threshold 26 to determine whether the data structures of the data structure group 12 are valid data structures 28 or invalid data structures 28. The discrepancy threshold may be a percentage of difference between or among performance scores. The discrepancy threshold may be an amount of difference between or among performance scores. The discrepancy threshold may be dynamic and change based on the user ID of the user requesting the output, the current interest rates or any other economic factor. If the amount of tax owed indicated by different tax returns differs beyond the discrepancy threshold, the system may determine that one or both tax returns may have errors or be imprecise or inaccurate.

In various embodiments, in response to the data structures being valid data structures 28, an output data structure selector 30 of the third processor 18 receives the valid data structures 28 and selects an approved data structure for outputting at a selected output data structure output 28. The selecting may be based on a first selection criteria 38 and the selection may be made from among the data structures of the data structure group 12 in response to the data structures being valid data structures 28. The first selection criteria may include (i) a lowest tax owed, (ii) a fewest deductions, (iii) a most deductions, (iv) a highest tax owed, (v) a lowest risk score, (vi) a highest risk score, and/or (vii) a weighted combination of criteria.

In some instances, the validator 24 determines that the data structures of the data structure group 12 are not valid data structures. For instance, the data structures each have a performance score that when differenced by the difference engine 20 to generate a difference score 22, causes the difference score 22 to exceed a threshold amount, such as a discrepancy threshold 26. In such instances, the validator 24 may provide the first output data structure 16 and the second output data structure 14 of the output data structure group 12 to a mediation engine 34. Stated another way, the system may apply a mediation procedure by the third processor 18 in response to the difference score being greater than or equal to the discrepancy threshold 26.

The mediation engine 34 may be a logical aspect of the third processor 18 configured to perform further processing, such as determining a further output data structure based on different assumptions, discarding one or more output data structure from the output data structure group 12 and/or generating a new data structure that may be approved for outputting at a selected output data structure output 36. The assumptions may include, for example, the decision to declare an expense as an amortizable deduction over time or as a loss against revenue in the current year. In various embodiments, the mediation engine can pursue a variety of options, and choose the best option based on a pre-configured bias such as, for example, minimizing the tax obligation or minimizing the likelihood of receiving a return, which itself can typically be computed as maximizing the tax obligation. In various embodiments, the mediation engine 34 at least one of (1) generates by a further processor, a further output data structure having a further performance score for inclusion in the output data structure group and/or (2) removes one or more output data structure from the output data structure group.

In various embodiments, the selected output data (e.g., a filing-ready tax return) is provided from the output data structure selector 30 at an output node 36 to a network 40. The output node 36 may be a computational step of relaying an output structure to network 40. The network 40 provides the selected output data (e.g., the “best” tax return) to a third-party computer system 42. In various embodiments, the third-party computer system 42 comprises a government tax return filing system configured to receive electronic tax returns.

The system may allow users to access data (e.g., tax records, tax forms, etc), and receive updated data in real time from other users. The system may store the data (e.g., in a standardized format) in a plurality of storage devices, provide remote access over a network so that users may update the data in a non-standardized format (e.g., dependent on the hardware and software platform used by the user) in real time through a GUI, convert the updated data that was input (e.g., by a user) in a non-standardized form to the standardized format, automatically generate a message (e.g., containing the updated data) whenever the updated data is stored and transmit the message to the users over a computer network in real time, so that the user has immediate access to the up-to-date data. The system allows remote users to share data in real time in a standardized format, regardless of the format (e.g. non-standardized) that the information was input by the user. The system may also include a filtering tool that is remote from the end user and provides customizable filtering features to each end user. The filtering tool may provide customizable filtering by filtering access to the data. The filtering tool may identify data or accounts that communicate with the server and may associate a request for content with the individual account. The system may include a filter on a local computer and a filter on a server.

The unstandardized formats may include, for example, unstructured, free-form text, key words spotted on forms (e.g., federal forms or tax filing forms), or any other format not explicitly intended to represent the tax information in a standardized form. Standardized forms may include, for example, IRS forms, JSON, YAML, XML or other common data formats configured to explicitly list tax information. For instance, the system could detect “$743.32” and “$512.89”, respectively, on a pair of invoices, each near the text “total”, and generate for demonstrative purposes only {“deductions”: [743.32, 512.89]}. Data can be filtered by the client, type of form, or relevance to a tax return. For instance, medical expenses may be filtered if they do not exceed the minimum threshold before the medical expenses are eligible as a deductible expense.

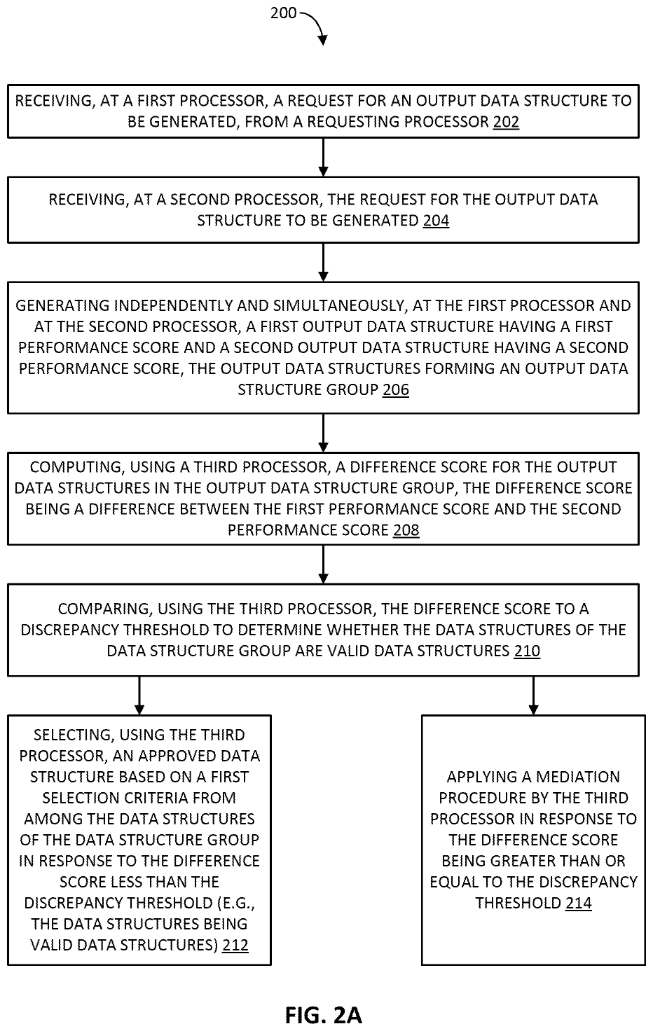

Attention is now directed to FIG. 2, for a discussion of a method 200 for automatically selecting an output data structure from among more than one output data structure generated by separate processors. As discussed previously, each output data structure may have a performance score. The method may include receiving, at a first processor, a request for an output data structure to be generated, from a requesting processor (block 202). The method may include receiving, at a second processor, the request for the output data structure to be generated (block 204). The method may include generating independently and simultaneously, at the first processor and at the second processor, a first output data structure having a first performance score and a second output data structure having a second performance score, the output data structures forming an output data structure group (block 206). The method may include computing, using a third processor, a difference score for the output data structures in the output data structure group, the difference score being a difference between the first performance score and the second performance score (block 208). In various instances, the method includes comparing, using the third processor, the difference score to a discrepancy threshold to determine whether the data structures of the data structure group are valid data structures (block 210). The method may include selecting, using the third processor, an approved data structure based on a first selection criteria from among the data structures of the data structure group in response to the data structures being valid data structures (block 212). In contrast, the method 200 include applying a mediation procedure by the third processor in response to the difference score being greater than or equal to the discrepancy threshold (block 214). The mediation procedure may include at least one of (1) generating by a further processor, a further output data structure having a further performance score for inclusion in the output data structure group and/or (2) removing one or more output data structure from the output data structure group.

Similarly, a non-transitory computer-readable medium is provided. The medium may include computer readable instructions, which when executed by a plurality of processors causes the plurality of processors to perform operations for automatically selecting an output data structure from among more than one output data structure generated by separate processors. The systems and methods discussed herein may operate to execute the instructions.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Terms and phrases similar to “associate” and/or “associating” may include tagging, flagging, correlating, using a look-up table or any other method or system for indicating or creating a relationship between elements, such as, for example, (i) a mandatory criteria and/or preferred criteria and (ii) a target criteria. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method known in the art.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQTM (formerly MQSeries) by IBM Inc. (Armonk, N.Y.) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA® devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME® , and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, crossover bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, ProX-Y based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set, e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM® -based network, a new data entry may become available within about 13-20 seconds as of the writing. On a HYPERLEDGER® Fabric 1.0 based platform, the duration is driven by the specific consensus algorithm that is chosen and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over conventional technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

Any communication, transmission, and/or channel discussed herein may include any system or method for delivering content (e.g., data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word or EXCEL™, an ADOBE® Portable Document Format (PDF) document, etc.), an “ebook,” an “emagazine,” an application or microapplication (as described herein), an short message service (SMS) or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

We claim:

1. A method comprising:
sending, by a requesting processor and to a first processor, a request for a first output data structure to be generated by the first processor;
sending, by the requesting processor and to a second processor, a request for a second output data structure to be generated by the second processor,
wherein the first processor and the second processor generate independently and simultaneously the first output data structure having a first performance score and the second output data structure having a second performance score, the first output data structure and the second output data structure forming an output data structure group;
computing, by the requesting processor, a difference score of the output data structure group, the difference score being a difference between the first performance score and the second performance score;
comparing, by the requesting processor, the difference score to a discrepancy threshold to determine whether the first output data structure and the second output data structure of the data structure group are valid data structures; and
selecting, using the requesting processor, an approved data structure based on a first selection criteria from among the first output data structure and the second output data structure of the data structure group, in response to at least one of the first output data structure or the second output data structure being a valid data structure.

2. The method of claim 1,
wherein the first output data structure is a first tax return,
wherein the second output data structure is a second tax return, and
wherein the request for an output data structure to be generated comprises a request for a tax return to be completed.

3. The method of claim 2, wherein the first performance score is a greater amount of taxes owed as indicated by the first tax return.

4. The method of claim 3, wherein the second performance score is a lesser amount of taxes owed as indicated by the second tax return.

5. The method of claim 4, wherein the approved data structure comprises a tax return to electronically file with a government computer system.

6. The method of claim 1, wherein the first processor forwards the request for the output data structure to be generated to the second processor after the receiving the request at the first processor.

7. The method of claim 1, wherein the first processor and the second processor both receive the request for the output data structure to be generated from the requesting processor.

8. The method of claim 5, wherein the discrepancy threshold is a percentage of difference amongst the tax returns.

9. The method of claim 5, wherein the discrepancy threshold is a magnitude of difference amongst the tax returns.

10. The method of claim 5 wherein the first selection criteria includes at least one of a lowest tax owed, a fewest deductions, a most deductions, a highest tax owed, a lowest risk score, a highest risk score or a weighted combination of criteria.

11. The method of claim 1 further comprising applying, by the requesting processor, a mediation procedure, in response to the difference score being greater than or equal to the discrepancy threshold.

12. The method of claim 11, further comprising:
generating, by the requesting processor, a further output data structure having a further performance score for inclusion in the output data structure group; and
removing, by the requesting processor, one or more output data structures from the output data structure group.

13. An article of manufacture including a non-transitory, tangible computer readable storage medium having instructions stored thereon that, in response to execution by a requesting processor, cause the requesting processor to perform operations comprising:
sending, by the requesting processor and to a first processor, a request for a first output data structure to be generated by the first processor;
sending, by the requesting processor and to a second processor, a request for a second output data structure to be generated by the second processor,
wherein the first processor and the second processor generate independently and simultaneously the first output data structure having a first performance score and the second output data structure having a second performance score, the first output data structure and the second output data structure forming an output data structure group;
computing, by the requesting processor, a difference score of the output data structure group, the difference score being a difference between the first performance score and the second performance score;
comparing, by the requesting processor, the difference score to a discrepancy threshold to determine whether the first output data structure and the second output data structure of the data structure group are valid data structures; and
selecting, using the requesting processor, an approved data structure based on a first selection criteria from among the first output data structure and the second output data structure of the data structure group in response to at least one of the first output data structure or the second output data structure being a valid data structure.

14. The non-transitory computer-readable medium according to claim 13,
wherein the first output data structure is a first tax return,
wherein the second output data structure is a second tax return, and
wherein the request for an output data structure to be generated comprises a request for a tax return to be completed.

15. The non-transitory computer-readable medium according to claim 14, wherein the first performance score is a greater amount of taxes owed as indicated by the first tax return.

16. The non-transitory computer-readable medium according to claim 15, wherein the second performance score is a lesser amount of taxes owed as indicated by the second tax return.

17. The non-transitory computer-readable medium according to claim 16, wherein the approved data structure comprises a tax return to electronically file with a government computer system.

18. The non-transitory computer-readable medium of claim 13, wherein the first processor forwards the request for the output data structure to be generated to the second processor after the receiving the request at the first processor.

19. The non-transitory computer-readable medium of claim 13, wherein the first processor and the second processor both receive the request for the output data structure to be generated from the requesting processor.

20. A system comprising:
a requesting processor; and
a tangible, non-transitory memory configured to communicate with the requesting processor,
the tangible, non-transitory memory having instructions stored thereon that, in response to execution by the requesting processor, cause the requesting processor to perform operations comprising:
sending, by the requesting processor and to a first processor, a request for a first output data structure to be generated by the first processor;
sending, by the requesting processor and to a second processor, a request for a second output data structure to be generated by the second processor,
wherein the first processor and the second processor generate independently and simultaneously the first output data structure having a first performance score and the second output data structure having a second performance score, the first output data structure and the second output data structure forming an output data structure group;
computing, by the requesting processor, a difference score of the output data structure group, the difference score being a difference between the first performance score and the second performance score;
comparing, by the requesting processor, the difference score to a discrepancy threshold to determine whether the first output data structure and the second output data structure of the data structure group are valid data structures; and
selecting, using the requesting processor, an approved data structure based on a first selection criteria from among the first output data structure and the second output data structure of the data structure group in response to at least one of the first output data structure or the second output data structure being a valid data structure.
